(19) United States
(12) Patent Application Publication
(10) Pub. No.: US 2026/0162906 A1
(43) Pub. Date: Jun. 11, 2026

(54) SEPARATOR FOR ELECTROCHEMICAL DEVICE, AND ELECTROCHEMICAL DEVICE

(71) Applicant: SAMSUNG ELECTRO-MECHANICS CO., LTD., Suwon-si (KR)

(72) Inventors: Si Ho Kim, Suwon-si (KR); Jung Deok Park, Suwon-si (KR)

(73) Assignee: SAMSUNG ELECTRO-MECHANICS CO., LTD., Suwon-si (KR)

(21) Appl. No.: 19/329,028

(22) Filed: Sep. 15, 2025

(30) Foreign Application Priority Data
Dec. 11, 2024 (KR) 10-2024-0183939

(51) Int. Cl. H01G 9/02; C25B 13/04; H01M 8/0245; H01M 8/0258; H01M 8/12

(52) U.S. Cl. CPC H01G 9/02; C25B 13/04; H01M 8/0245; H01M 8/0258; H01M 2008/1293

(57) ABSTRACT

A separator for an electrochemical device includes a main plate and a protrusion disposed on at least one among one side and the other side of the main plate facing each other and having one end connected to the main plate and the other end being movable, wherein the main plate includes an accommodation space in which the other end of the protrusion moves.

### CROSS-REFERENCE TO RELATED APPLICATIONS

This application claims benefit of priority to Korean Patent Application No. 10-2024-0183939 filed on Dec. 11, 2024 in the Korean Intellectual Property Office, the disclosure of which is incorporated herein by reference in its entirety.

### TECHNICAL FIELD

The present disclosure relates to a separator for an electrochemical device and an electrochemical device.

Electrochemical devices include fuel cells generating electrical energy by electrochemically reacting fuel (hydrogen) with an oxidizer (pure oxygen or atmospheric oxygen), electrolysis cells generating hydrogen and oxygen through electrolysis of water.

As examples of such electrochemical devices, solid oxide fuel cells (SOFCs) and solid oxide electrolysis cells (SOECs) include cells including an air electrode, a fuel electrode, and a solid electrolyte having oxygen ion conductivity, and the cell may be referred to as a solid oxide cell. A solid oxide cell generates electrical energy through an electrochemical reaction or produces hydrogen by electrolyzing water through a reverse reaction of a solid oxide fuel cell. In addition, other types of fuel cells or electrolytic cells, such as phosphoric acid fuel cells (PAFC), alkaline fuel cells (AFC), polymer electrolyte fuel cells (PEMFC), and direct methanol fuel cells (DMFC), have also been used as a type of electrochemical device.

In the case of electrochemical devices, it is common to use a stack structure in which unit cells are arranged between a pair of separators, and in this case, the separators may electrically connect the cells in series. During an operation of the electrochemical device, the pressure applied to an interface between the separators and the cells may change, and if excessive pressure is applied, the cell may be damaged.

### SUMMARY

An aspect of the present disclosure is to provide a separator for an electrochemical device, capable of improving current collection efficiency, structural stability, and the like, when applied to an electrochemical device.

According to an aspect of the present disclosure, a separator for an electrochemical device includes: a main plate; and a protrusion disposed on at least one among one side and the other side of the main plate facing each other and having one end connected to the main plate and the other end being movable, wherein the main plate includes an accommodation space in which the other end of the protrusion moves.

The protrusion may be elastically deformable.

The main plate may include a stack structure of a first plate and a second plate, and the second plate may include the accommodation space.

The other end of the protrusion may be in contact with one surface of the first plate.

The accommodation space may be a through-hole formed in the second plate.

A thickness of the other end of the protrusion may be the same as a thickness of the second plate.

The protrusion may include a first support portion connected to the main plate and extending outwardly of the main plate, a connection portion extending from the first support portion in a direction, parallel to the main plate, and a second support portion extending from the connection portion toward the main plate.

The second support portion may be connected to the other end of the protrusion.

Thicknesses of the first support portion, the connection portion, and the second support portion may be the same as the thickness of the second plate.

A sum of lengths of the first support portion, the connection portion, the second support portion, and the other end in the extended direction may be the same as a length of the through-hole.

The protrusion may be disposed on one side of the main plate, and the main plate further may include a flow path disposed on the other side.

The protrusions may be arranged on one side and the other side of the main plate.

According to another aspect of the present disclosure, a separator for an electrochemical device includes: a main plate; and a protrusion disposed on at least one among one side and the other side of the main plate facing each other and having one end connected to the main plate and the other end being movable, wherein one end and the other end of the protrusion are located on the same level.

The main plate may include a stack structure including a first plate and a second plate, and the second plate may include a through-hole accommodating the other end of the protrusion.

The other end of the protrusion may be in contact with one surface of the first plate.

According to another aspect of the present disclosure, an electrochemical device includes: a plurality of separators; and an electrochemical cell disposed between the plurality of separators, wherein at least one of the plurality of separators includes a main plate; and a protrusion disposed on at least one among one side and the other side of the main plate facing each other and having one end connected to the main plate and the other end being movable, wherein the main plate may include an accommodation space in which the other end of the protrusion moves.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a perspective view schematically illustrating the exterior of a separator for an electrochemical device according to an embodiment of the present disclosure;

FIG. 2 is a perspective view illustrating a protrusion and a surrounding region thereof that may be employed in a separator for an electrochemical device;

FIG. 3 is a cross-sectional view illustrating a protrusion and a surrounding region thereof that may be employed in a separator for an electrochemical device;

FIG. 4 illustrates the movement of a protrusion when pressure is applied to a separator for an electrochemical device;

FIG. 5 is a cross-sectional view illustrating a protrusion and a surrounding region thereof that may be employed in a separator for an electrochemical device according to a modified example;

FIG. 6 is a cross-sectional view illustrating a protrusion and a surrounding region thereof that may be employed in a separator for an electrochemical device according to a modified example; and

FIG. 7 illustrates a water electrolysis device to which a separator according to an embodiment of the present disclosure is applied.

### DETAILED DESCRIPTION

Hereinafter, embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising”, will be understood to imply the inclusion of stated elements but not the exclusion of any other elements.

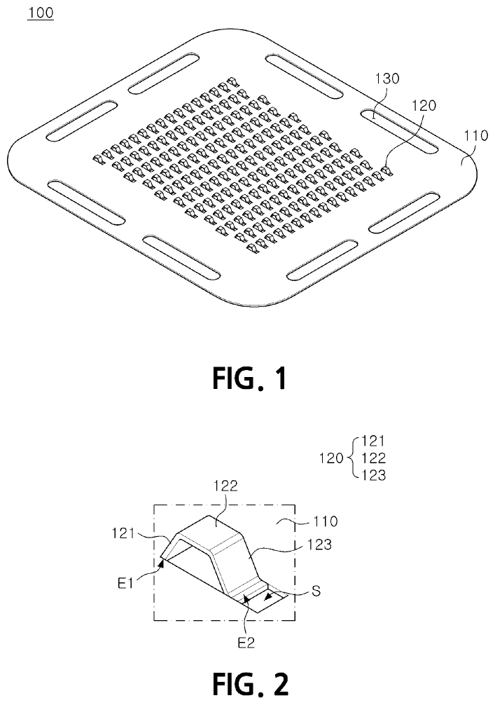

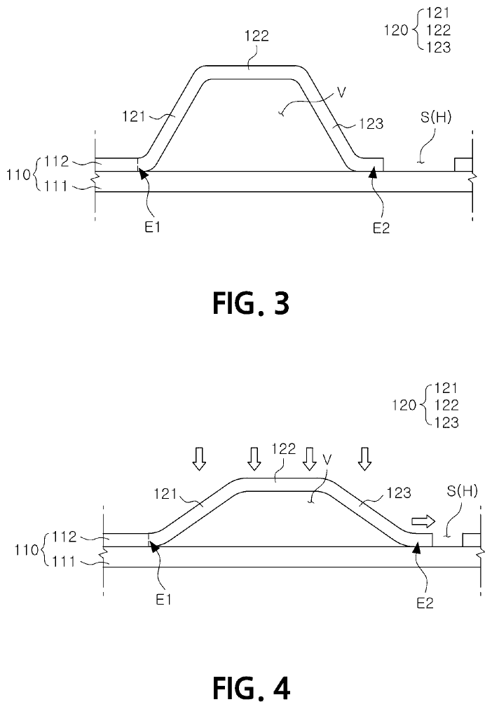

FIG. 1 is a perspective view schematically illustrating the exterior of a separator for an electrochemical device according to an embodiment of the present disclosure, FIG. 2 is a perspective view illustrating a protrusion and a surrounding region thereof that may be employed in a separator for an electrochemical device, FIG. 3 is a cross-sectional view illustrating a protrusion and a surrounding region thereof that may be employed in a separator for an electrochemical device, and FIG. 4 illustrates the movement of a protrusion when pressure is applied to a separator for an electrochemical device.

Referring to FIGS. 1 to 3, a separator 100 for an electrochemical device (hereinafter referred to as a “separator for an electrochemical device” or “separator”) according to an embodiment of the present disclosure includes a main plate 110 and a protrusion 120 arranged on at least one of one side and the other side of the main plate 110 facing each other, and in the present embodiment, a structure in which the protrusion 120 is arranged on an upper surface of the main plate 110 is described. In the case of the protrusion 120, one end E1 is connected to the main plate 120 and the other end E2 is movable. In addition, the main plate 110 includes an accommodation space S in which the other end E2 of the protrusion 120 may move. In addition, regardless of the presence of the accommodation space S in the main plate 110, one end E1 and the other end E2 of the protrusion 120 are located on the same level, which is of the main features of the protrusion 120. Here, in the case in which one end E1 and the other end E2 of the protrusion 120 are located on the same level, when pressure is applied to the protrusion 120, the other end E2 of the protrusion 120 moves, so that the protrusion 120 may be effectively deformed.

In the related art, it was common to use spherical or square column-shaped protrusions as a current collecting protrusion structure of the separator, and such protrusions may apply excessive pressure to a cell, thereby causing problems, such as deformation or damage of a cell and decreased current collecting efficiency. In the present embodiment, since the other end E2 of the protrusion 120 is movable, the protrusion 120 may be easily deformed, and since the protrusion 120 may be deformed in accordance with the deformation of the cell, the current collecting efficiency thereof may be improved, while not applying excessive pressure to the cell, thereby reducing the possibility of damage to the cell.

The main plate 110 constituting the separator 1100 is a component that separates each unit cell in an electrochemical device and may be formed of a conductive material. Specifically, the main plate 110 may include a metal with a high melting point so as not to melt or soften at high temperatures when used as an SOEC or SOFC. For example, the main plate 110 may include a nickel-based, iron-based, stainless-based, or other material. In addition, if an operating temperature of the main plate 110 is relatively low, for example, at about 800° C. or lower, copper or a copper alloy with good conductivity may also be used. A plurality of fluid exits 130 may be formed in an outer portion of the main plate 110.

As described above, in the protrusion 120, one end E1 may be connected to the main plate 120 and the other end E2 is movable, and here, the other end E2 may be disposed in the accommodation space S of the main plate 110. The protrusion 120 may be a current collecting structure in contact with the electrochemical cell and may be deformed when pressure is applied. To this end, the protrusion 120 may be elastically deformable. In this case, the protrusion 120 may be obtained by cutting a portion of the main plate 110 and then bending the cutout portion to form a protrusion structure, and in this process, the accommodation space S of the main plate 110 may also be obtained.

In terms of effectively functioning the protrusion 120, the main plate 110 may be implemented as a multilayer structure. Specifically, as illustrated in the form illustrated in FIG. 3, the main plate 110 may include a stack structure of the first plate 111 and the second plate 112, and in this case, the second plate 112 located relatively above may include the accommodation space S. Here, “above” corresponds to a direction in which the protrusion 120 protrudes. The accommodation space of the main plate 110 may be a through-hole H formed in the second plate 112. When the main plate 110 has a multilayer structure, the other end E2 of the protrusion 120 may be in contact with one surface (an upper surface in the drawing) of the first plate 111. When downward pressure is applied to the protrusion 120 as the other end E2 of the protrusion 120 is in contact with one surface of the first plate 111, the other end E2 of the protrusion 120 may move laterally in the accommodation space S, and accordingly, the protrusion 120 may be effectively deformed in accordance with the deformation of the electrochemical cell. As described above, the protrusion 120 may be obtained by cutting a portion of the main plate 110 and then bending a cutout portion to form a protrusion structure, and in this case, a thickness of the other end E2 of the protrusion 120 may be the same as a thickness of the second plate 112.

Referring to a shape of the protrusion 120, in detail, the protrusion 120 may include a first support portion 121 connected to the main plate 110 and extending to the outside (the upper side in the drawing) of the main plate 110, a connection portion 122 extending from the first support portion 121 in a direction, parallel to the main plate 110, and a second support portion 123 extending from the connection portion 122 toward the main plate 110. In this case, the first support portion 121 and the second support portion 122 may extend in a diagonal direction with respect to one surface of the second plate 122. In addition, the second support portion 122 may be connected to the other end E2. As illustrated, thicknesses of the first support portion 121, the connection portion 122, and the second support portion 123 may be the same as the thickness of the second plate 112, and this thickness condition may be obtained by cutting a portion of the second plate 112 and then bending the same to form the first support portion 121, the connection portion 122, the second support portion 123, and the like. In addition, in this case, a total length of the protrusion 120, that is, the sum of the lengths in the direction in which the first support portion 121, the connection portion 122, the second support portion 123, and the other end E2 extend, respectively, may be the same as the length of the through-hole H.

Referring to FIG. 4, as described above, when downward pressure is applied to the protrusion 120, the other end E2 of the protrusion 120 may move laterally in the accommodation space S, and accordingly, the protrusion 120 may be effectively deformed in accordance with the deformation of the electrochemical cell. However, in FIG. 4, the other end E2 of the protrusion 120 is illustrated to move only laterally (in a horizontal direction), but depending on the size or direction of the applied pressure, the other end E2 of the protrusion 120 may move upward of the main plate 110.

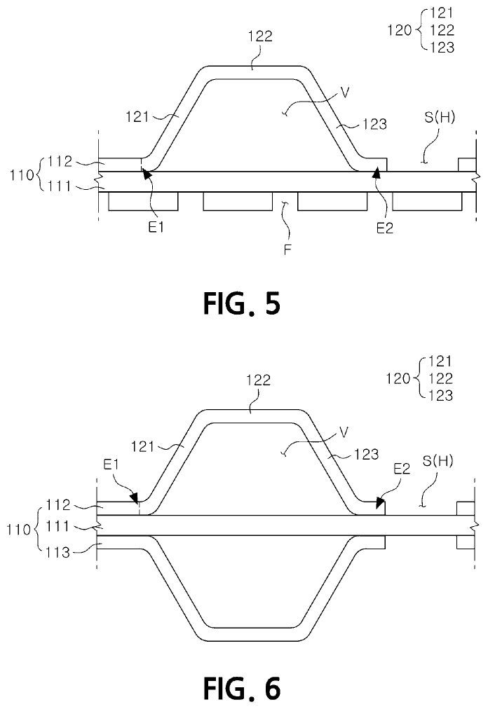

Referring to FIGS. 5 and 6, a separator for an electrochemical device according to a modified example will be described. First, in the modified example of FIG. 5, the protrusion 120 is arranged on one side of the main plate 110, and the main plate 110 further includes a flow path F disposed on the other side. Here, the flow path F may be formed by processing the first plate 111 or obtained by coupling a separate plate. In addition, as in the modified example of FIG. 6, a structure in which the protrusions 120 are arranged on one side (the upper side in the drawing) and the other side (the lower side) of the main plate 110 may also be adopted. In order to implement the additional protrusions 120, the main plate 110 may include a third plate 113 arranged on the other side of the first plate 111, and the third plate 113 may have the same structure as that of the first plate 111.

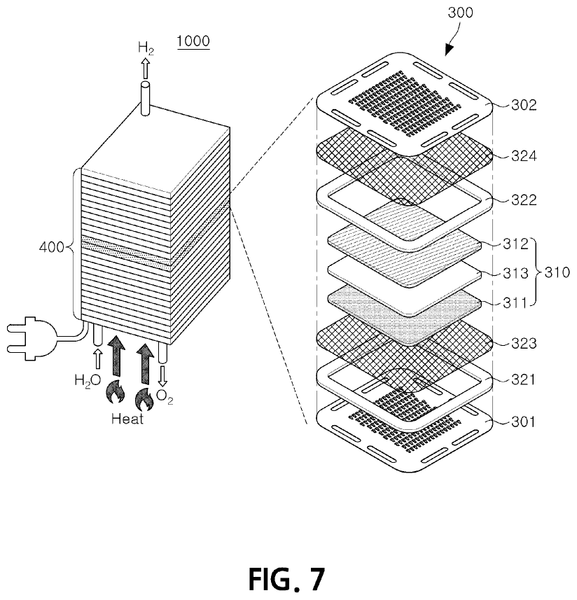

An example of applying the separator described above to an electrochemical device is described with reference to FIG. 7. FIG. 7 illustrates a water electrolysis device to which the separator having a current collecting protrusion structure described above is applied. However, the separator of the above-described type may be applied to other types of electrochemical devices, such as fuel cells, not water electrolysis devices. Referring to FIG. 7, a water electrolysis device 1000 includes a plurality of separators 301 and 302 and an electrochemical cell 310 disposed therebetween. Water in the form of vapor is supplied as fuel to the water electrolysis device 1000, and water may be separated into hydrogen and oxygen through electrolysis. In order to improve the function of the water electrolysis device 1000, a plurality of units 300 including the separators 301 and 302 and the electrochemical cell 310 may be provided and repeated to form a stack 400. Referring to the components of the unit 300, the unit 300 may include a fuel electrode side separator 301 and an air electrode side separator 302. In this case, the fuel electrode side separator 301 may be implemented in a form in which the other end E2 of the protrusion 120 is movable in the accommodation space S of the main plate 110 as described above, thereby improving the performance of the electrolysis device 1000. In FIG. 7, the separator according to the embodiment of FIG. 1 is used, but a separator according to another embodiment may also be employed. In addition, the shape of the air electrode side separator 302 is not limited, but the air electrode side separator 302 may also include a path having the same shape as that of the fuel electrode side separator 301.

In the case of the electrochemical cell 310, as an example, a solid oxide cell may be used. Specifically, the electrochemical cell 310 may include a fuel electrode 311, an air electrode 312, and an electrolyte 313 disposed therebetween. Here, the fuel electrode 311 may include a cermet layer including a metal-containing phase and a ceramic phase. Here, the metal-containing phase may include a metal catalyst, such as nickel (Ni), cobalt (Co), copper (Cu), or an alloy thereof, which acts as an electron conductor. The metal catalyst may be in a metal state or an oxide state. The ceramic phase of the fuel electrode 311 may include gadolinia-doped ceria (GDC), samaria-doped ceria (SDC), yttria-doped ceria (YDC), scandia-stabilized zirconia (SSZ), ytterbia-ceria-scandia-stabilized zirconia (YbCSSZ), and the like. The air electrode 312 may include an electrically conductive material, such as an electrically conductive perovskite material, such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or a metal, such as Pt, may also be used. In some embodiments, the air electrode 312 may include a mixture of an electrically conductive material and an ionically conductive ceramic material. For example, the air electrode 123 may include about 10wt % to about 90wt % of an electrically conductive material (e.g., LSM, etc.) and about 10wt % to about 90wt % of an ionically conductive material. Here, the ionically conductive material may include a zirconia-based and/or ceria-based material. The electrolyte 313 may include stabilized zirconia. Specifically, the electrolyte 313 may include scandia-stabilized zirconia (SSZ), yttria-stabilized zirconia (YSZ), scandia-ceria-stabilized zirconia (SCSZ), scandia-ceria-yttria-stabilized zirconia (SCYSZ), scandia-ceria-ytterbia-stabilized zirconia (SCYbSZ), etc.

Meanwhile, although the electrochemical cell 310 is described above as a solid oxide cell, the electrochemical cell 310 may also be employed as a polymer electrolyte membrane cell, etc.

Gaskets 321 and 322 may be disposed in an outer portion of the electrochemical cell 310 between the separators 301 and 302 to prevent fluid from leaking out externally. Also, porous conductive layers 323 and 324 may be arranged between the separators 301 and 302 and the electrochemical cell 310. It is preferable that the porous conductive layer 323 and 324 has excellent oxidation resistance to maintain excellent electrical conductivity. In addition, as illustrated, the porous conductive layers 323 and 324 may have a mesh structure, etc. so that a fluid may pass therethrough.

In the case of a separator for an electrochemical device according to an example of the present disclosure, a high level of current collection efficiency and structural stability may be exhibited at the interface with the cell. Therefore, when such a separator is applied to an electrochemical device, improved performance may be provided.

While embodiments have been illustrated and described above, it will be apparent to those skilled in the art that modifications and variations could be made without departing from the scope of the present disclosure as defined by the appended claims.

What is claimed is:

1. A separator for an electrochemical device, the separator comprising:
a main plate; and
a protrusion disposed on at least one among one side and the other side of the main plate facing each other and having one end connected to the main plate and the other end being movable,
wherein the main plate includes an accommodation space in which the other end of the protrusion moves.

2. The separator of claim 1, wherein the protrusion is elastically deformable.

3. The separator of claim 1, wherein the main plate includes a stack structure of a first plate and a second plate, and the second plate includes the accommodation space.

4. The separator of claim 3, wherein the other end of the protrusion is in contact with one surface of the first plate.

5. The separator of claim 3, wherein the accommodation space is a through-hole formed in the second plate.

6. The separator of claim 3, wherein a thickness of the other end of the protrusion is the same as a thickness of the second plate.

7. The separator of claim 3, wherein the protrusion includes a first support portion connected to the main plate and extending outwardly of the main plate, a connection portion extending from the first support portion in a direction, parallel to the main plate, and a second support portion extending from the connection portion toward the main plate.

8. The separator of claim 7, wherein the second support portion is connected to the other end of the protrusion.

9. The separator of claim 7, wherein thicknesses of the first support portion, the connection portion, and the second support portion are the same as the thickness of the second plate.

10. The separator of claim 7, wherein a sum of lengths of the first support portion, the connection portion, the second support portion, and the other end in an extended direction is the same as a length of the through-hole.

11. The separator of claim 1, wherein the protrusion is disposed on one side of the main plate, and the main plate further includes a flow path disposed on the other side.

12. The separator of claim 1, wherein protrusions are arranged on one side and the other side of the main plate.

13. A separator for an electrochemical device, the separator comprising:
a main plate; and
a protrusion disposed on at least one among one side and the other side of the main plate facing each other and having one end connected to the main plate and the other end being movable,
wherein one end and the other end of the protrusion are located on the same level.

14. The separator of claim 13, wherein the main plate includes a stack structure including a first plate and a second plate, and the second plate includes a through-hole accommodating the other end of the protrusion.

15. The separator of claim 13, wherein the other end of the protrusion is in contact with one surface of the first plate.

16. An electrochemical device comprising:
a plurality of separators; and
an electrochemical cell disposed between the plurality of separators,
wherein at least one of the plurality of separators includes:
a main plate; and
a protrusion disposed on at least one among one side and the other side of the main plate facing each other and having one end connected to the main plate and the other end being movable,
wherein the main plate includes an accommodation space in which the other end of the protrusion moves.

17. The electrochemical device of claim 16, wherein the protrusion is elastically deformable.

18. The electrochemical device of claim 16, wherein the main plate includes a stack structure of a first plate and a second plate, and the second plate includes the accommodation space.

19. The electrochemical device of claim 18, wherein the other end of the protrusion is in contact with one surface of the first plate.

20. The electrochemical device of claim 18, wherein the accommodation space is a through-hole formed in the second plate.
